(19) United States
(12) Patent Application Publication
(10) Pub. No.: US 2014/0175851 A1
(43) Pub. Date: Jun. 26, 2014

(54) SEAT SPRING BASE FOR A VEHICLE SEAT AND LOWER SEAT STRUCTURE WITH THE SEAT SPRING BASE

(71) Applicant: GM GLOBAL TECHNOLOGY OPERATIONS LLC, Detroit, MI (US)

(72) Inventors: Andrew LEUCHTMANN, Mandel (DE); Dieter FUCHS, Hochheim (DE); Joerg WIEGELMANN, Bodenheim (DE)

(73) Assignee: GM GLOBAL TECHNOLOGY OPERATIONS LLC, Detroit, MI (US)

(21) Appl. No.: 14/097,093

(22) Filed: Dec. 4, 2013

(30) Foreign Application Priority Data
Dec. 5, 2012 (DE) 10 2012 023 771.5

(51) Int. Cl. B60N 2/68

(52) U.S. Cl. CPC B60N 2/68
USPC 297/452.18

(57) ABSTRACT

A seat spring base is provided for a vehicle seat. The seat spring base encompasses a seat mat and coupling elements. The coupling elements are designed to be coupled with a seat frame of the vehicle seat. The coupling elements each form a receiving area for the seat frame, and each exhibit a functional section. The receiving area is arranged between the functional sections and the seat mat. The functional sections are spaced a distance A apart from each other, and the seat spring base exhibits a bridging device to bridge the distance. The bridging device is arranged on the functional sections of the at least two coupling elements.

### CROSS-REFERENCE TO RELATED APPLICATION

This application claims priority to German Patent Application No. 10 2012 023 771.5, filed Dec. 5, 2012, which is incorporated herein by reference in its entirety.

### TECHNICAL FIELD

The technical field relates to a seat spring base for a vehicle seat and a lower seat structure with the seat spring base.

### BACKGROUND

Nearly every vehicle integrates vehicle seats that exhibit a lower seat structure with a seat spring base. The seat spring base is often secured to a seat frame. The seat frame usually imparts stiffness to the vehicle seat, and in addition to the seat spring base also carries a backrest and seat padding.

For example, Publication DE 10 2006 032 038 A1 describes a lower seat structure for a vehicle seat. The vehicle seat encompasses a seat frame and seat spring base, which is secured to the seat frame. To this end, the seat frame exhibits a receptacle, which is designed to attach the seat spring base to the seat frame.

### SUMMARY

At least one object is to provide a functional seat spring base. In addition, other objects, desirable features and characteristics will become apparent from the subsequent summary and detailed description, and the appended claims, taken in conjunction with the accompanying drawings and this background.

A seat spring base is provided for a vehicle seat, in particular a driver or passenger seat. The vehicle seat is preferably designed for integration into a passenger car or truck. The seat spring base encompasses a seat mat and at least two coupling elements. The seat mat preferably has bent and interconnected, crossing and/or intermeshed wires, and in particular exhibits a defined ductility. In particular, the seat mat has an elastic and/or flexible design, so that it can impart a feeling of comfort to a passenger sitting in the vehicle seat.

The coupling elements be connected with the seat mat. In particular, the coupling elements are comprised of free ends of the wires in the seat mat. The coupling elements are designed to be coupled with a seat frame of the vehicle seat. The seat mat can preferably be positively and/or non-positively secured to the seat frame by way of the coupling elements. The seat frame is optionally designed to impart enough stability to the vehicle seat, and carry additional components of the vehicle seat.

The at least two coupling elements each form a receiving area for the seat frame. The seat frame can preferably be arranged in the receiving area, and thus can be positively and/or non-positively secured to the seat spring base. It is especially preferred that the seat spring base be mounted in the seat frame by way of the coupling elements. The at least two coupling elements each exhibit a functional section. The functional sections preferably encompass areas of contact with the seat frame and/or can be arranged thereon so as to establish contact. In particular, the functional sections are used to at least partially convey retaining forces from the seat spring base to the seat frame in order to hold the seat spring base on the seat frame. The receiving area is arranged between the functional sections and the seat mat. In particular, the functional sections are arranged on the one side of the receiving area, and the seat mat is arranged on the opposing side.

The functional sections are spaced a distance apart from each other. The distance preferably runs parallel to a transverse extension of the seat frame and/or the seat mat. The seat spring base exhibits a bridging device to bridge the distance. The bridging device is arranged on the functional sections of the at least two coupling elements. In particular, the functional sections spaced apart from each other by the distance are joined together by the bridging device.

It is advantageous that the at least two coupling elements are stabilized and/or reinforced by the bridging device arranged on the functional sections. As a consequence, the seat mat can advantageously be reliably secured to the seat frame by way of the coupling elements, even given an elevated, in particular punctiform, load. In particular, the coupling elements can be prevented from deforming, opening or detaching from the seat frame, or the coupling elements can be prevented from displacing in the transverse extension by integrating the seat spring base into a lower seat structure.

In an embodiment, the bridging device is designed as a surface component. The bridging device preferably joins the functional sections together in a planar manner, and thereby bridges the distance between the functional sections. The bridging device forms a shared visible face for the functional sections. The shared visible face is later concealed by a seat cover, in particular during completion of the lower seat structure or the vehicle seat.

With the seat spring base built into a lower seat structure of the vehicle seat and the vehicle seat mounted in the vehicle, the visible face is oriented toward a rear compartment or tail of the vehicle. In particular, the visible face partially borders a foot well of a rear seat passenger. It is here oriented toward a rear seat or rear seat bench of the vehicle.

The bridging device balances out the functional sections as interfering contours, thereby making it possible to avoid damages to the seat cover that is stretchable or stretched over the bridging device. In particular, the bridging device is designed as a shared end side of the functional sections. The bridging device makes it possible to distinctly diminish or even entirely eliminate a seat padding of the lower seat structure in the area of the coupling elements so as to cover the latter and balance out the irregularities on the seat frame caused by the coupling elements. Economizing on seat padding in the area of the coupling elements makes it possible to generate more legroom for rear compartment passengers in the vehicle, who are sitting on the rear seat or rear seat bench. In particular, the economized or eliminated padding volume is made available as legroom for the rear compartment passengers. Economizing or eliminating the padding enables a reduction in material and weight in the vehicle, which can yield cost advantages. The expanded legroom also increases customer satisfaction.

It is preferred that the functional section be shielded and/or covered by the bridging device. As an alternative or optional enhancement, the functional sections are at least partially, preferably completely, integrated into the bridging device. The advantage to both potential measures is that the visible face of the bridging device can be configured independently of the coupling elements, or that it at least offers a greater creative leeway.

The visible face of the bridging device is designed as a strip or plate that is flat and/or radius-free, in particular straight. Alternatively, the visible face of the bridging device can be designed as a curved cover and/or hood. In particular, the bridging device as the curved cover and/or hood exhibits a radius or radius progression. As a consequence, the bridging device can be tailored to the outer contour or a progression of the functional sections.

The visible face of the bridging device as viewed from above exhibits a rectangular or essentially rectangular outer contour. It is also possible for the bridging device to exhibit an elongated, oval outer contour. The visible face of the bridging device can be invariable, elevation-free and/or continuous in design. In particular, the bridging device exhibits little or no irregularities, shoulders or steps.

Securing the bridging device to the functional sections makes it possible to advantageously implement a planar surface appearance. In particular, irregularities caused by the coupling elements as they envelop the seat frame can be offset and straightened. This yields in particular optical advantages when covering the vehicle seat, especially the lower seat structure.

The bridging device exhibit or form at least one interface for attaching a or the seat cover of the vehicle seat. For example, the interface is designed as a latching contour or a latching receptacle. The seat cover then exhibits the corresponding mating component for the latching receptacle or latching contour. For example, buttons or a button tab can be provided as the latching contour, while buttonholes can be provided as the latching receptacle. It is also possible for the interface to be designed as a Velcro strip. It is advantageous that the at least one interface eliminates the need for a separate attachment to the lower seat structure for the seat cover, thereby making it possible to save on costs and installation space.

The bridging device exhibits a lower edge, which is designed as a tensioning edge for the seat cover. The tensioning edge is optionally radius-free and angular in design. The lower edge is advantageously bent or curved in a direction oriented toward the receiving area, so that the seat cover can be tensioned around the latter easily and without any damage. As a consequence, the seat cover can be easily and quickly mounted without any wrinkles.

In an embodiment, the bridging device is comprised of a plastic material. The bridging device is preferably materially bonded with the functional sections. For example, the functional sections are encapsulated with the bridging device in an injection molding process, or the bridging device is gated onto the functional sections.

The at least two coupling elements are designed as at least two hooks. It is especially preferred that the at least two coupling elements be designed as a series of hooks. The characteristic bend or curve in the at least two hooks advantageously yield the receiving area. In particular, the at least two hooks envelop the seat frame when the latter is arranged in the receiving area.

A the lower seat structure is also provided that encompasses a seat frame, which forms a component of a base framework for the vehicle seat. The seat frame is preferably designed to impart enough stability to the vehicle seat, and in addition to the seat spring base, for example, also carry a backrest, a seat padding and any vehicle seat controls that may be provided. The seat frame is arranged in the receiving areas of the at least two coupling elements, and thereby coupled with the coupling elements, so as to form at least two coupling areas.

The bridging device extends parallel and/or aligned to the seat frame. In particular, the bridging device covers and/or screens the at least two coupling areas. The bridging device thus preferably forms the visible face or end face of the coupling areas. As a result, a planar surface appearance can advantageously be implemented in the coupling areas. In particular, irregularities caused by the coupling elements as they envelop the seat frame can be offset and straightened. This yields in particular optical advantages when covering the lower seat structure with a or the seat cover. The lower seat structure advantageously encompasses the seat cover, along with a seat padding as an optional enhancement.

It is further advantageous that the seat padding of the lower seat structure in the area of the coupling elements can be distinctly diminished or even entirely eliminated by the bridging device for covering the latter and balancing out the irregularities caused by the coupling areas. Economizing on seat padding in the area of the coupling elements makes it possible to generate more legroom for rear compartment passengers in the vehicle, who are sitting on the rear seat or rear seat bench. In particular, the economized or eliminated padding volume is made available as legroom for the rear compartment passengers. Economizing or eliminating the padding enables a reduction in material and weight in the vehicle, which can yield cost advantages. The expanded legroom also increases customer satisfaction.

### BRIEF DESCRIPTION OF THE DRAWINGS

The present invention will hereinafter be described in conjunction with the following drawing figures, wherein like numerals denote like elements, and:

FIG. 1 is a lower seat structure with a seat spring base for a vehicle seat;

FIG. 2 is the seat spring base with a seat mat, a plurality of coupling elements and a bridging device;

FIG. 3 is a detailed view of coupling areas between the coupling elements from FIG. 2 and a seat frame of the lower seat structure from FIG. 1; and

FIG. 4 is a the lower seat structure from FIG. 1, wherein the lower seat structure is covered with a seat cover.

### DETAILED DESCRIPTION

The following detailed description is merely exemplary in nature and is not intended to limit application and uses. Furthermore, there is no intention to be bound by any theory presented in the preceding background or summary or the following detailed description.

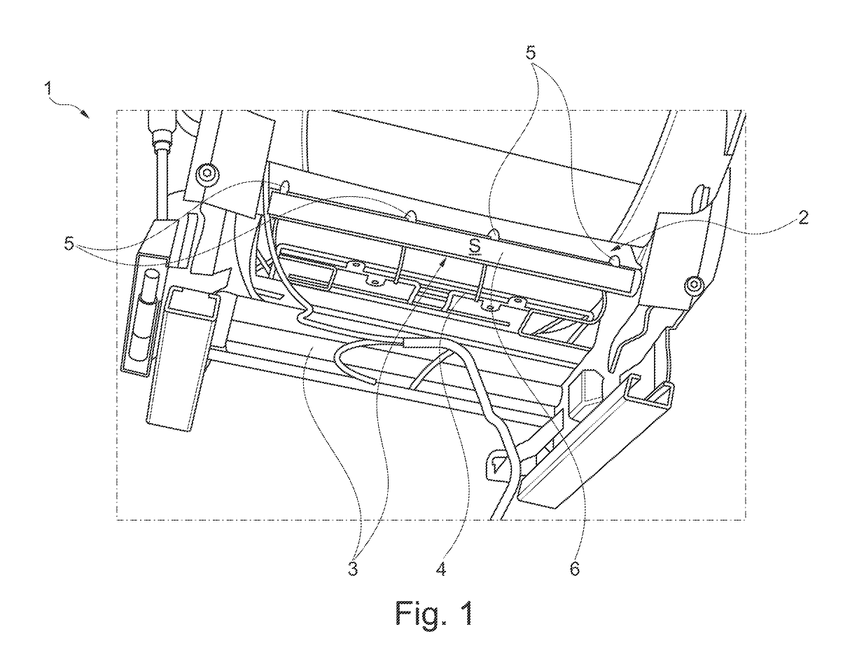

FIG. 1 shows a lower seat structure 1 for a vehicle seat, preferably a front seat, which can be arranged in a passenger car or truck. The lower seat structure 1 exhibits a seat spring base 2 and a seat frame 3. The seat frame 3 is designed as a tubular framework. It forms a component of a base framework for the vehicle seat. In this function, it is designed to stabilize the vehicle seat, in particular the lower seat structure, and also carries a seat padding and seat rest of the vehicle seat.

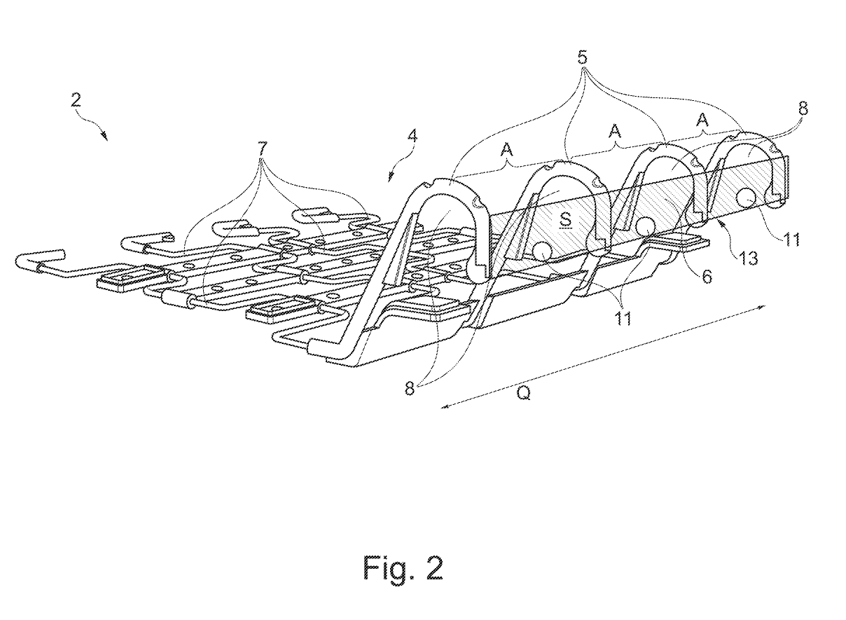

The seat spring base 2 is shown in detail on FIG. 2. It encompasses a seat mat 4, a plurality of coupling elements, e.g., four, and a bridging device 6. The seat mat 4 consists of a plurality of metal wires 7 that are bent in a wavelike manner and interconnected. It is designed to cushion the vehicle seat, and its resiliency imparts a feeling of comfort to a passenger sitting in the vehicle seat.

The coupling elements 5 are connected with the seat mat 4. In particular, the wires 7 of the seat mat 4 pass over into the coupling elements 5. The number of wires 7 preferably corresponds to the number of coupling elements 5. The coupling elements 5 together form a hook rail, in which they are arranged spaced apart from each other by distance A. Distance A extends parallel to a transverse extension Q of the seat mat 4 and seat frame 3 (FIG. 1). The coupling elements 5 are designed for positively and/or non-positively coupling with the seat frame 3. The seat spring base 2, in particular the seat mat 4, can here be connected with the seat frame 3 by way of the coupling elements 5.

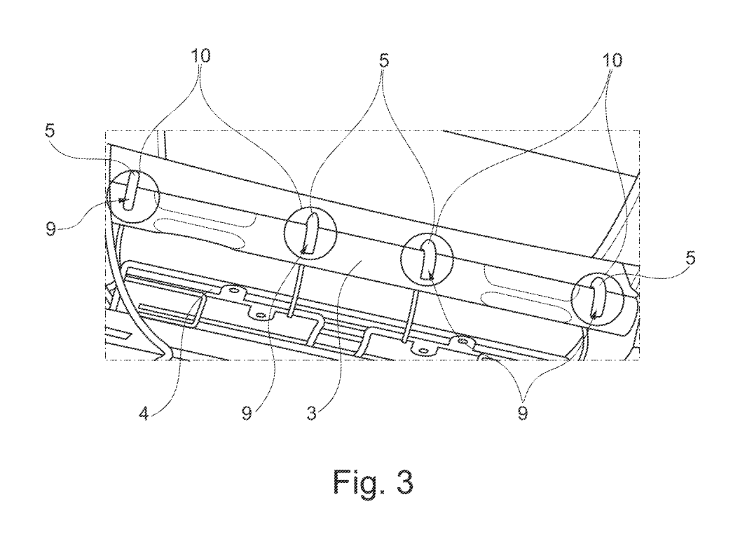

For purposes of connection with the seat frame 3, the coupling elements 5 are designed like hooks, and each exhibit a receiving area 8 for the seat frame 3. As shown in a detailed representation on FIG. 3 that omits the bridging device 6, the seat frame 3 is arranged in the receiving areas 8 with the lower seat structure 1 completely assembled. The coupling elements 5 here envelop the seat frame 3 positively and/or non-positively, and form corresponding coupling areas 10.

The coupling elements 5 each exhibit a functional sections 9 spaced apart from the seat mat 4 by the receiving areas 8 or by the seat frame 3 arranged in the receiving areas 8. In particular, the receiving areas 8 or seat frame 3 are arranged between the seat mat 4 and the functional sections 9. The functional sections 9 are designed to at least partially convey retention forces, with which the seat spring base 2, in particular the seat mat 4, can be secured to the seat frame 3. With the vehicle seat built into the vehicle, the functional sections 9 are oriented toward a rear seat or rear seat bench of the vehicle.

As shown on FIG. 1 and FIG. 2, the bridging device 6 is arranged on the functional sections 9. It extends along the coupling elements 5 and parallel to the seat frame 3 arranged in the receiving areas 8. In this arrangement, the bridging device 6 forms a shared visible face S for the functional sections 9. The bridging device 6 stabilizes the coupling elements, so that the seat frame can be prevented from opening, detaching or sliding off

In its basic form, the bridging device 6 is designed on the visible face S as a rectangular, planar, in particular straight, strip or plate. Alternatively, the visible face S of the bridging device 6 can also be designed as a curved cover or hood. A radius progression of the bridging device 6 is preferably tailored or identical to an outer contour and/or a progression of the coupling elements 5, in particular of the functional sections 9.

The bridging device 6 bridges the distance A arranged between the coupling elements 5. The bridging device 6 exhibits an invariable, elevation-free and continuous surface, which forms the visible face S. The bridging device 6 is made out of a plastic material, and materially bonded with the functional sections 9. In particular, the bridging device 6 is gated onto the functional sections. In an alternative exemplary embodiment, the functional sections 9 can also be encapsulated with the plastic material that comprises the bridging device 6, and integrated into the latter. Alternatively, the bridging device can be secured to the functional sections 9 in some other suitable manner, e.g., clipped or slipped onto the functional sections 9.

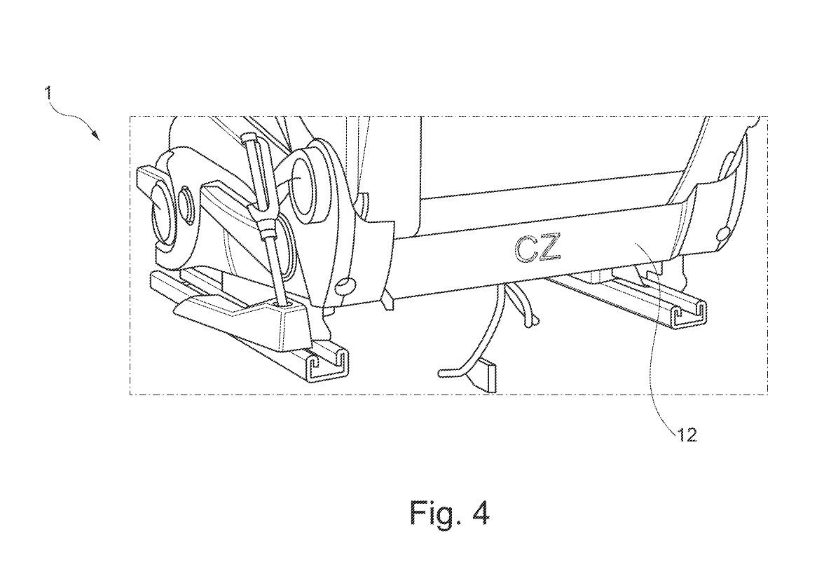

The bridging device 6 shields and/or covers the functional sections 9 or coupling areas 10, and forms the visible face S or end face for the latter. The visible face or end face is usually covered with a seat cover 12 in a subsequent step in the manufacture of the lower seat structure 1 (FIG. 4). After the vehicle seat has been installed in the vehicle, the bridging device 6 is preferably oriented as the visible face S or end face toward the rear seat or rear seat bench of the vehicle.

The bridging device 6 exhibits at least one, e.g., three interfaces 11 for securing the seat cover 12 of the lower seat structure 1. The interfaces 11 are preferably arranged on the back, in particular in relation to the visible face S or end face. The interfaces 11 are designed as latching contours, e.g., buttons or a button tab, or as a latching receptacle, e.g., as buttonholes. In this configuration, the interfaces 11 are preferably molded onto the bridging device 6, or introduced while injection molding the plastic material. However, it is also possible for the at least one interface 11 to be designed as a Velcro strip or some other suitable fastening means, and attached, e.g., adhesively bonded, to the bridging device 6.

The bridging device 6 exhibits a tensioning edge 13 for tensioning the seat cover 12. While covering the lower seat structure, the seat cover 12 can be pulled over the tensioning edge 13, and thereby smoothed out. The tensioning edge 13 can be angular or preferably rounded in a direction oriented toward the seat mat 4.

FIG. 4 shows the lower seat structure 1 of the vehicle seat, wherein the lower seat structure 1 encompasses the seat cover 12. The visible face or end face of the lower seat structure 1 is covered with the seat cover 12, wherein the visible face S is concealed by the seat cover 12. The seat cover 12 is attached to the at least one interface 11, and tensioned around the tensioning edge 13 of the bridging device 6, as the result of which the seat cover 12 is secured to the lower seat structure 1 without any wrinkles.

Since the bridging device 6 shields and/or covers the functional sections 9 and/or the coupling areas 10, its shape and contour cannot be delineated through the seat cover 12. Instead, the elevation-free and steady visible face S of the bridging device 6 forms an optically appealing bottom support for the seat cover 12, so that the latter can also be smoothly and steadily secured without any elevations. In particular, there is no need for an additional seat pad usually situated under the seat cover 12 for concealing the functional sections 9 and/or coupling elements 5, and preventing any delineation under the seat cover 12. This makes it possible to advantageously economize on padding material, weight and costs. In addition, economizing on padding material expands the legroom for a rear compartment passenger sitting on the rear seat or rear seat bench.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A seat spring base for a vehicle seat, comprising:
a seat mat;
a first coupling element and a second coupling
element that are coupled with a seat frame of the vehicle seat, wherein the first-coupling element and the second coupling elements (5) each form a receiving area for the seat frame and each comprise a functional section, wherein the receiving area is arranged between the functional sections and the seat mat, wherein the functional sections are spaced a distance apart;
a bridging device that bridges the distance and is arranged on the functional sections of the first coupling element and the second coupling elements.

2. The seat spring base according to claim 1, wherein the bridging device is a surface component that joins the functional sections together in a planar manner.

3. The seat spring base according to claim 1, wherein the bridging device forms a shared visible face for the functional sections.

4. The seat spring base according to claim 3, wherein the functional sections are shielded by the bridging device.

5. The seat spring base according to claim 3, wherein the visible face of the bridging device is a planar.

6. The seat spring base according to one of claim 4, wherein the visible face of the bridging device is a curved cover.

7. The seat spring base according to claim 3, wherein the visible face of the bridging device is invariable and elevation-free.

8. The seat spring base according to claim 1, wherein the bridging device comprises an interface for attaching a seat cover of the vehicle seat.

9. The seat spring base according to claim 8, wherein a lower edge of the bridging device is a tensioning edge for the seat cover.

10. The seat spring base according to claim 1, wherein the bridging device is comprised of a plastic material.

11. The seat spring base according to claim 1, wherein the bridging device is materially bonded with the functional sections.

12. The seat spring base according to claim 1, wherein the bridging device is gated onto the functional sections.

13. The seat spring base according to claim 1, wherein the first coupling elements is a first hook and the second coupling element is a second hook.

14. A lower seat structure for a vehicle seat, comprising:
a seat mat;
a first coupling element and a second coupling element that are coupled with a seat frame of the vehicle seat, wherein the first coupling element and the second coupling element each form a receiving area for the seat frame and each comprise a functional section, wherein the receiving area is arranged between the functional sections and the seat mat, wherein the functional sections are spaced a distance apart; and
a bridging device that bridges the distance and is arranged on the functional sections of the first coupling element and the second coupling element,
wherein the seat frame form a component of a base framework of the vehicle seat, wherein the seat frame is arranged in the receiving areas of the first coupling element and the coupling elements, and couple with the first coupling element and the second coupling element so as to form at least two coupling areas (10).

15. The lower seat structure according to claim 14, wherein the bridging device extends parallel to the seat frame.

16. The lower seat structure according to claim 14, wherein the bridging device is a surface component that joins the functional sections together in a planar manner.

17. The lower seat structure according to claim 14, wherein the bridging device forms a shared visible face for the functional sections.

18. The lower seat structure according to claim 17, wherein the functional sections are shielded by the bridging device.

19. The lower seat structure according to claim 17, wherein the visible face of the bridging device is a planar strip.

20. The lower seat structure according to claim 19, wherein the visible face of the bridging device is a curved cover.
